(19) United States
(12) Patent Application Publication
(10) Pub. No.: US 2026/0154939 A1
(43) Pub. Date: Jun. 4, 2026

(54) IMAGE FEATURE MATCHING LOCALIZATION SYSTEM AND METHOD

(71) Applicant: INDUSTRIAL TECHNOLOGY RESEARCH INSTITUTE, Chutung (TW)

(72) Inventors: Yao-Chin YANG, Hsinchu City (TW); Ting-Wei FAN, Taoyuan City (TW); Yi-Yu SU, Hsinchu City (TW); Kun-Hsien LU, Kaohsiung City (TW)

(73) Assignee: INDUSTRIAL TECHNOLOGY RESEARCH INSTITUTE, Chutung (TW)

(21) Appl. No.: 19/247,586

(22) Filed: Jun. 24, 2025

(30) Foreign Application Priority Data
Dec. 4, 2024 (TW) 113147057

(51) Int. Cl. G06V 10/75; G06V 10/26; G06V 10/44; G06V 10/50; G06V 10/74; G06V 10/762; G06V 10/766

(52) U.S. Cl. CPC G06V 10/751; G06V 10/26; G06V 10/44; G06V 10/50; G06V 10/759; G06V 10/761; G06V 10/762; G06V 10/766

(57) ABSTRACT

The application discloses an image feature matching localization system and method. After processing a plurality of input images (having a local image with an unknown location and a plurality of global images with known locations) through feature analysis and feature matching, the localization result of the local image are outputted. This localization result indicates the corresponding partial contour region of the local image and the matching partial contour region of the global image.

This application claims the benefit of Taiwan Patent application Serial No. 113147057, filed Dec. 4, 2024, the disclosure of which is incorporated by reference herein in its entirety.

### TECHNICAL FIELD

The disclosure relates to an image feature matching localization system and method.

### BACKGROUND

Currently, pipeline maintenance in the petrochemical industry relies on manual visual inspections, where personnel must climb and walk along pipelines to detect surface corrosion or degradation. Inspectors take photos and record the locations of any issues they find. However, due to obstructions from structural elements, GPS signals are often weak or inaccurate. As a result, inspectors can only estimate locations using nearby pipe rack numbers or manually annotate the location information. After inspections are completed, personnel must manually sort and compare large volumes of similar pipeline images, a process that is time-consuming, labor-intensive, and prone to filing errors.

In large-scale pipeline storage and transportation facilities (such as petrochemical raw material storage and refining plants), pipe racks can extend for tens of kilometers, with total pipeline lengths reaching thousands of kilometers. To maintain the efficiency and safety of these extensive pipelines and reduce carbon emissions (by preventing temperature fluctuations or leaks), inspection and maintenance have become critical tasks for petrochemical plant operations. Currently, inspections are still conducted manually, with personnel climbing the pipe racks and taking photos for documentation. However, given the vast coverage and the high environmental similarity, manually organizing and locating a large volume of similar inspection images is both time-consuming and challenging.

During pipeline inspections, personnel photograph and document any signs of cracking or corrosion on the pipeline surfaces. However, due to the highly similar appearance of the environment, it becomes difficult to manually identify the correspondence between images and their exact pipeline locations during the archiving process. To address this issue, technologies using image analysis for feature matching localization have been proposed. Since pipelines are cylindrical, the visible range in images typically covers up to 180 degrees. Different shooting angles can lead to variations in the visible areas of the pipeline surface, resulting in overlapping and non-overlapping regions during feature matching, which can introduce noise and affect the accuracy of the comparison.

The application discloses an image feature matching localization method and system based on image feature analysis. By utilizing both local and global image feature descriptors, the system analyzes similarities and matches corresponding regions to achieve accurate localization. The proposed method enhances matching accuracy by filtering non-overlapping feature points and conducting further analysis and extraction of overlapping features based on the characteristics of the environment. This allows for effective image matching localization even in highly similar environments and from unknown shooting angles.

### SUMMARY

According to one embodiment, an image feature matching localization method is provided. The image feature matching localization method includes: performing feature analysis on a local image and a plurality of global images to obtain respective feature points and respective feature descriptor of the local image and the global images; partitioning the local image into a plurality grid blocks; performing feature matching between the feature points of a first grid block of the local image and the feature points of the global images to obtain a plurality of feature point matching results; performing clustering analysis on the feature point matching results to calculate a target region of one of the global images corresponding to the first grid block, wherein the target region satisfies a first condition indicating that a first feature point average neighboring distance of the target region is less than or equal to a second feature point average neighboring distance of the first grid block of the local image; determining whether to retain or discard the feature points within the first grid block based on a feature point matching relationship and whether corresponding to the target region in the global image; analyzing a first pipeline direction of the first grid block in the local image and a second pipeline direction of the target region in the global image, calculating a first angle between the first pipeline direction and a first feature point regression line in the local image, and calculating a second angle between the second pipeline direction and a second feature point regression line in the global image; adjusting the selection of feature points by calculating a feature point set such that an angular difference between the first angle and the second angle is less than a threshold value; performing outer contour region analysis based on a feature point distribution from a regression analysis result of the global image to obtain a grid block localization result; and performing spatial union processing based on a set of localization results of the grid blocks corresponding to the global images, and calculating an outer contour spatial region as a localization result of the local image on the global images.

According to another embodiment, an image feature matching localization system is provided. The image feature matching localization system includes: a storage unit; a display unit; and a processor, coupled to and control the storage unit and the display unit. The processor is configured for: performing feature analysis on a local image and a plurality of global images to obtain respective feature points and respective feature descriptor of the local image and the global images; partitioning the local image into a plurality grid blocks; performing feature matching between the feature points of a first grid block of the local image and the feature points of the global images to obtain a plurality of feature point matching results; performing clustering analysis on the feature point matching results to calculate a target region of one of the global images corresponding to the first grid block, wherein the target region satisfies a first condition indicating that a first feature point average neighboring distance of the target region is less than or equal to a second feature point average neighboring distance of the first grid block of the local image; determining whether to retain or discard the feature points within the first grid block based on a feature point matching relationship and whether corresponding to the target region in the global image; analyzing a first pipeline direction of the first grid block in the local image and a second pipeline direction of the target region in the global image, calculating a first angle between the first pipeline direction and a first feature point regression line in the local image, and calculating a second angle between the second pipeline direction and a second feature point regression line in the global image; adjusting the selection of feature points by calculating a feature point set such that an angular difference between the first angle and the second angle is less than a threshold value; performing outer contour region analysis based on a feature point distribution from a regression analysis result of the global image to obtain a grid block localization result; and performing spatial union processing based on a set of localization results of the grid blocks corresponding to the global images, and calculating an outer contour spatial region as a localization result of the local image on the global images.

### BRIEF DESCRIPTION OF THE DRAWINGS

FIG. 1 illustrates a flowchart of the image feature matching localization method according to one embodiment of the application.

FIG. 2 shows the local image feature block partitioning step (131) of the image feature matching localization method according to one embodiment of the application.

FIG. 3 illustrates the block-to-global image matching step 133 of the image feature matching localization method according to one embodiment of the application.

FIG. 4 demonstrates the feature point clustering analysis step (141) of the image feature matching localization method according to one embodiment of the application.

FIG. 5 illustrates the feature point regression similarity analysis step (143) of the image feature matching localization method according to one embodiment of the application.

FIG. 6 shows the block localization step 151 of the image feature matching localization method according to one embodiment of the application.

FIG. 7 illustrates the block localization fusion step of the image feature matching localization method in one embodiment of the application.

FIG. 8 illustrates a functional block diagram of an image feature matching localization system according to an embodiment of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

In one embodiment of the image feature matching localization system and method presented in the application, the input images include a local image (an image with an unknown location) and multiple global images (images with known locations). After processing the input images through feature analysis and feature matching, the system outputs the localization result of the local image. This result indicates the corresponding partial contour region of the local image and the matching partial contour region of the global image.

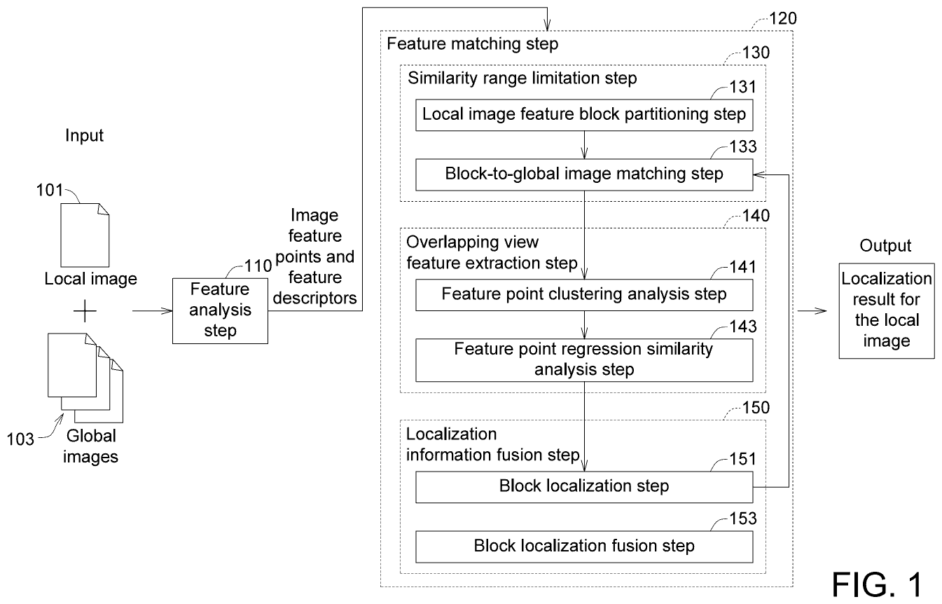

FIG. 1 illustrates a flowchart of the image feature matching localization method according to one embodiment of the application. The input includes: a local image (unknown location image) 101 and multiple global images (known location images) 103. The local image 101 is the image to be matched and localized. Both the single local image 101 and the global images 103 undergo a feature analysis step 110 to extract image feature points and feature descriptors. For example, though not limited to, the feature analysis step 110 may employ computer vision (CV) feature algorithms or artificial intelligence (AI) neural networks to conduct preliminary image feature analysis, generating feature points and descriptors used as inputs for the feature matching step 120.

The feature matching step 120 has three sub-steps: (1) similarity range limitation step 130 including: local image feature block partitioning step 131 and block-to-global image matching step 133; (2) overlapping view feature extraction step 140, including: feature point clustering analysis step 141 and feature point regression similarity analysis step 143; and (3) localization information fusion step 150, including: block localization step 151 and block localization fusion step 153.

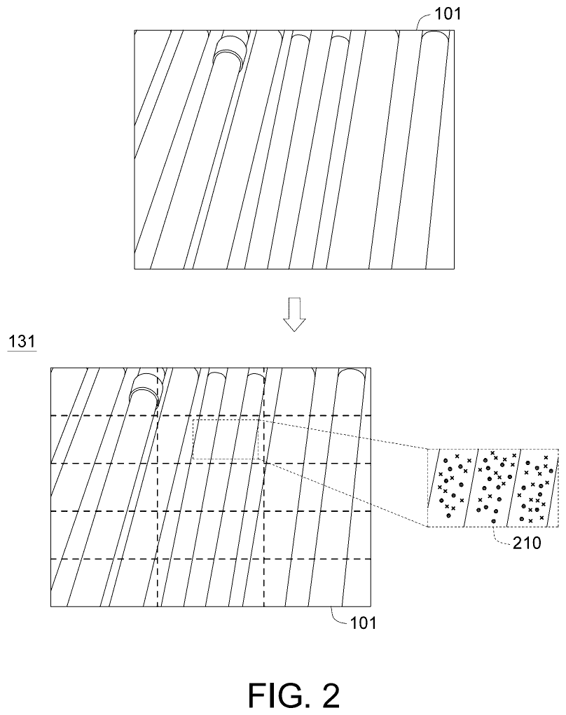

FIG. 2 shows the local image feature block partitioning step (131) of the image feature matching localization method according to one embodiment of the application. The purpose of the local image feature block partitioning step 131 is to restrict the repetitive similarity regions of the local image 101 to reduce noise interference during subsequent feature matching. As shown in FIG. 2, using a resolution of 2344×1639 and applying a Scale-Invariant Feature Transform (SIFT) algorithm as an example (though the method is not limited to this), the analysis of local image 101 extracts 3,739 feature points and 3739 corresponding feature descriptors. The local image feature block partitioning step 131 determines the grid size to constrain the processing blocks, setting a maximum number “n” of feature points per grid block (e.g., n=500). After calculating appropriate grid rows and columns, for example, a grid size of 3×5 is obtained. Subsequent processing is conducted on a block-by-block basis. FIG. 2 also shows the local image 101 partitioned into grid blocks, along with detailed feature information 210 for each block.

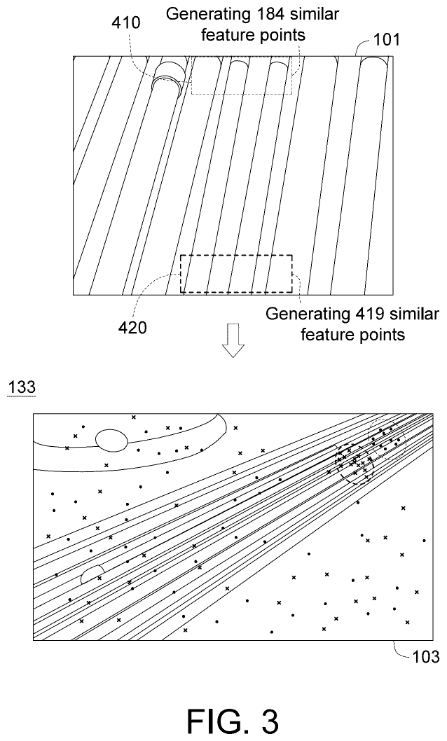

FIG. 3 illustrates the block-to-global image matching step 133 of the image feature matching localization method according to one embodiment of the application. The block-to-global image matching step 133 aims to match the feature points within each grid block to those in the global images, providing a coarse localization region. As shown in FIG. 3, by applying the same feature extraction algorithm in the step 131 to the global images 103, 54589 feature points and 54589 feature descriptors are obtained, for example but not to limit the application. Each grid blocks of the local image 101 is compared to the global images 103 using feature similarity algorithms, such as Fast Library for Approximate Nearest Neighbors (FLANN) and L2 normalization, to determine coarse localization of each grid block of the local image 101 at the global images 103. By the block-to-global image matching step 133, it is observed that, when the feature points from the local image 101 overlap with viewpoint from the global images 103, the spatial distribution between the feature points from the local image 101 and viewpoint from the global images 103 is maintained. Otherwise, mismatched features are scattered. For instance, in FIG. 3, grid blocks 410 and 420 of the local image 101 show 184 and 419 similar feature points, respectively.

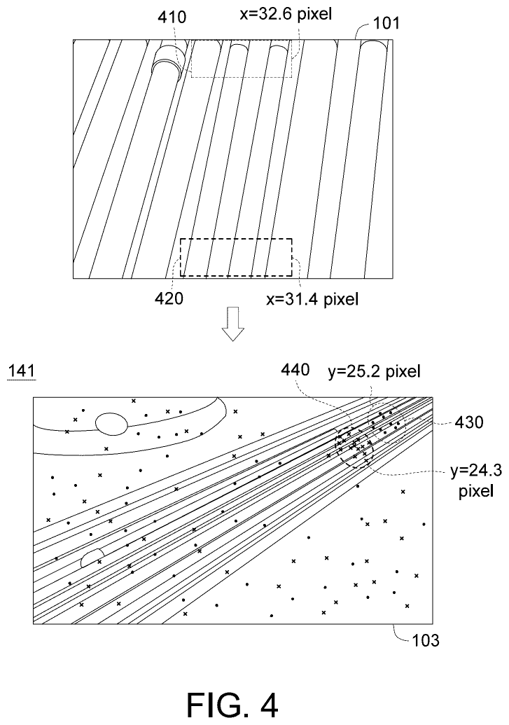

FIG. 4 demonstrates the feature point clustering analysis step (141) of the image feature matching localization method according to one embodiment of the application. The feature point clustering analysis step 141 aims to set clustering standards to initially identify overlapping regions. For example, in FIG. 4, the feature point average neighboring distance in grid blocks 410 and 420 of the local image 101 is calculated as “x” (for example, the average neighboring distance “x” of feature points in grid blocks 410 and 420 of the local image 101 is calculated as x=32.6 pixels and x=31.4 pixels, respectively). The feature point average neighboring distance “x” is defined as:

$$x = \frac{\sum pixel distance between one feature point and a closet feature point}{total numbe of feature points}$$

Corresponding to the grid blocks, coarse localization target regions 430 and 440 in the global image 103 have the feature point average neighboring distance “y” (for example but not limited by, coarse localization target regions 430 and 440 in the global image 103 have the feature point average neighboring distance “y” as y=25.2 pixels and y=24.3 pixels, respectively). The coarse localization target regions 430 and 440 in the global image 103 are corresponding to the grid blocks 410 and 420 of the local image 101. Since the global image has a wider view, y should be less than or equal to x (y≤x). If y>x, an optimization method (such as an iterative approach) is used to select a feature point from the global image and remove the selected feature point, aiming to maximize the reduction of the “y” value until the condition is met. If all feature points are removed and the condition (y≤x) is still not satisfied, it indicates that there is no overlapping region between the grid block and the global image. For each grid block of the local image 101, after performing steps 131, 133, and 141, the feature points corresponding to the discarded feature points from the global image, based on the matching relationship established in step 133, are also removed from the grid block. After conducting feature point cluster analysis step 141, the remaining feature points represent the preliminary result of the viewpoint overlap analysis.

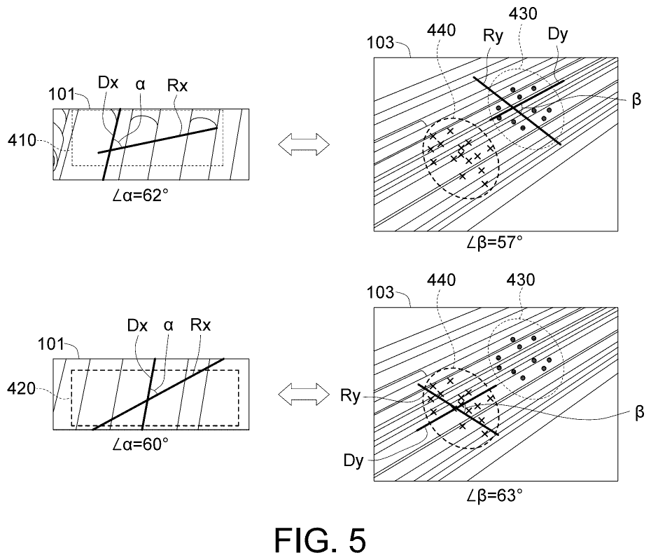

FIG. 5 illustrates the feature point regression similarity analysis step (143) of the image feature matching localization method according to one embodiment of the application. The feature point regression similarity analysis step 143 is to ensure the similarity of regression line orientations between the local and global images, for refining the overlapping areas. As shown in FIG. 5, based on the feature point analysis result of the feature point clustering analysis step 141, the feature point regression line Rx (for example but not limited by, a bivariate linear regression line) of the grid blocks 410 and 420 of the local image 101 and the feature point regression line Ry (for example but not limited by, a bivariate linear regression line) of the target regions (also called “the overlap regions”) 430 and 430 of the global image 103 are calculated, respectively. Using the pipeline direction as the reference baseline, the pipeline line functions are obtained through edge detection. The pipeline line functions of the local image 101 in grid blocks 410 and 420 are designated as Dx, while the pipeline line functions of the target region (or overlapping region) 430 and 440 in the global image 103 are designated as Dy. To extract detailed overlapping regions, feature point filtering is performed by ensuring similarity in the angles between two sets of line segments (Dx and Rx, as well as Dy and Ry). The angle between the line segment Rx and Dx in a grid block (such as 410 and 420) is defined as ∠α (for example, but not limited to, the angles for grid blocks 410 and 420 are ∠α=62° and ∠α=60°, respectively). Similarly, the angle between Ry and Dy in the target region (such as 430 and 440) of the global image is defined as ∠β (for example, but not limited to, ∠β=57° and ∠β=63° for regions 430 and 440, respectively). The following condition must be satisfied: ∠α=∠β±∠γ (where ∠γ is, for example but not limited to, 5°). If the angles ∠α and ∠β do not meet this condition, an optimization method (such as an iterative approach) is applied to remove mismatched feature points from both the local image 101 and the global image 103. This ensures that the remaining feature points yield recalculated regression line angles ∠α and ∠β that better satisfy the condition ∠α=∠β±∠γ. If all feature points are removed and the condition is still not met, the corresponding grid block will be disregarded. The feature points selected during the feature point regression similarity analysis step 143 represent the final results of the detailed overlapping region analysis based on perspective.

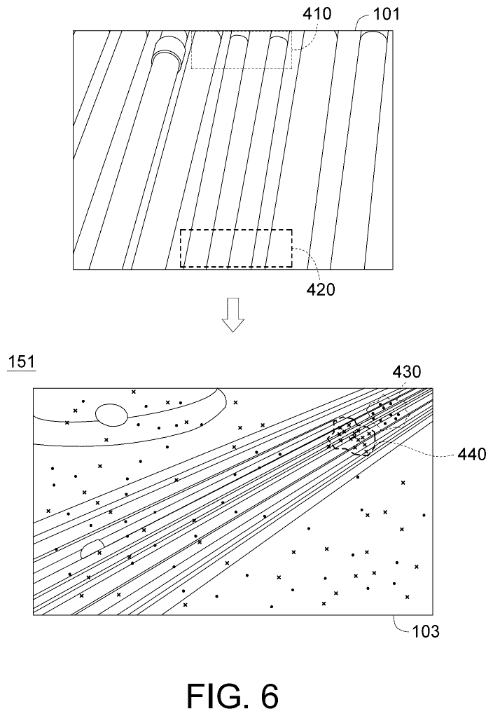

FIG. 6 shows the block localization step 151 of the image feature matching localization method according to one embodiment of the application. The purpose of the block localization step 151 is to analyze the contours of feature points within detailed overlapping regions to obtain the localization result of the corresponding block. As shown in FIG. 6, based on the feature point regression similarity analysis results from the feature point regression similarity analysis step 143 for the target regions (such as 430 and 440) of the global image, the minimum external contour boundary is calculated using the coordinate information of the feature points. This boundary represents the localization result of the corresponding grid blocks (such as 410 and 420) in the local image 101 (as indicated by the outer contours of the target regions 430 and 440 in FIG. 6). By sequentially applying steps 133 to 151 to all grid blocks of the local image 101, a complete set of localization results corresponding to the grid blocks in the global image can be obtained.

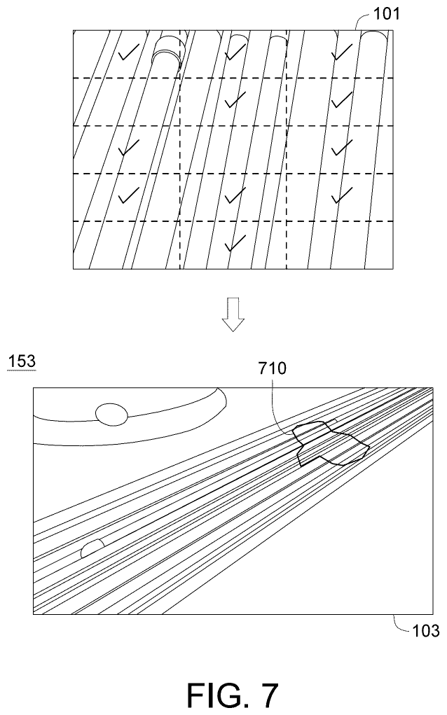

FIG. 7 illustrates the block localization fusion step of the image feature matching localization method in one embodiment of the application. The purpose of the block localization fusion step 153 is to perform a range union operation on the set of localization results from all grid blocks to obtain a complete localization result. As shown in FIG. 7, the range union operation is applied to the set of localization results of all grid blocks corresponding to the global image 103. The minimum external contour boundary is then calculated, representing the complete localization result 710 of the local image 101 corresponding to the global image 103.

After the feature matching step 120, the localization result of the local image 101 is output. The localization result includes the partial contour region of the local image 101 that matches with a corresponding partial contour region of the global image 103.

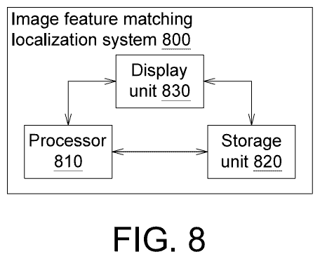

FIG. 8 illustrates a functional block diagram of an image feature matching localization system according to an embodiment of the present invention. The image feature matching localization system 800 includes: a processor 810, a storage unit 820, and a display unit 830. The processor 810 is coupled with and controls both the storage unit 820 and the display unit 830. When the processor 810 loads a local image (101) and multiple global images (103) from the storage unit 820, the processor 810 can execute the aforementioned image feature matching localization method and display the localization result on the display unit 830.

As described above, the image feature matching localization method and system proposed in one embodiment can achieve accurate localization in high-similarity scenarios.

In other words, in the image feature matching localization method and system proposed in one embodiment, feature analysis is performed on the local image and the global image using a feature analysis algorithm to obtain feature points and feature descriptors of both the local image and the global image set. The local image is partitioned into grid blocks, and feature matching is conducted between the feature points within each grid block and the feature points in the global image set. Clustering analysis is performed on the matching results of the feature points from the global image to calculate a target region (corresponding to a target grid block of the local image) of the global image, where the feature point average neighboring distance within the target region is less than or equal to the feature point average neighboring distance in a target grid block of the local image. Based on the feature point matching relationship, only features corresponding to those within a specific region of the global image are retained in the grid region. Edge detection is used to analyze the pipeline direction within a grid block of the local image and the pipeline direction within the overlapping region (i.e., the corresponding feature point area) of the global image. A first angle is calculated between the pipeline direction of the local image and the regression line of the feature points, and a second angle is calculated between the pipeline direction of the global image and the regression line of the feature points. Feature point selection is then adjusted to determine the optimal set of feature points such that the difference between the first and second angles is below a threshold value. Based on the feature point distribution from the global image's regression analysis, a minimum outer contour region analysis is conducted to obtain the localization result of the grid block. A spatial union operation is performed on the localization result set of the global image corresponding to each grid block, and the minimum outer contour spatial region is calculated, which serves as the localization result of the local image corresponding to the global image.

Furthermore, in one embodiment, the matching results of the feature points in the global image are subjected to cluster density analysis. An iterative optimization method is used to calculate a specific region of the global image where the feature point average neighboring distance is less than or equal to that of the corresponding grid block in the local image. If this condition cannot be met, it indicates that the grid block does not overlap with the global image.

Additionally, in one embodiment, the optimal feature point set is determined so that the angular difference between the first and second angles is smaller than the threshold value. If no optimal solution is found, that grid block will be disregarded. The resulting feature point sets represent the detailed feature point analysis of overlapping regions from different perspectives.

In one embodiment, based on the feature point distribution from the regression analysis of the global image, a minimum outer contour region analysis is performed to obtain the localization result of each grid block. Each grid block is processed individually using the above method to generate a localization result set corresponding to the global image.

The application proposes an image feature matching localization method and system based on feature analysis, which utilizes the feature descriptors of local and global images to analyze similarities and identify matching regions for localization. The proposed method and system, designed for specific environmental characteristics, achieve high-efficiency matching and accurate localization. Non-overlapping region feature points are filtered out, while overlapping region feature points are further analyzed and extracted to improve matching accuracy, even in high-similarity scenarios and with unknown camera angles.

In one embodiment, after performing feature analysis on visible light images, feature data is further refined on a grid-block basis. Clustering and regression techniques are used to optimize feature point selection, achieving effective matching localization.

It is understood that, to achieve the aforementioned functionality, the image feature matching localization system includes corresponding hardware structures and/or software modules that execute specific functions. Professionals skilled in the technical field will readily recognize that, by combining the units and algorithmic steps described in this specification, the present application can be implemented in hardware form or as a combination of hardware and computer software. Whether the functions are performed by hardware alone or by hardware driven by computer software depends on the specific application and design constraints of the technical solution. Skilled professionals can employ different methods to implement the functions described for each specific application, without departing from the scope of this application.

In one embodiment of this application, the image feature matching localization system can be divided into functional modules based on the method described above. For example, the division can be made according to each corresponding function to obtain individual functional modules, or two or more functions can be integrated into a single processing module. The integrated module can be implemented in hardware form or as a software functional module. It should be noted that, in this embodiment, dividing into modules is merely an example of logical functional segmentation. Other methods of division can be used during practical implementation. The following description uses an example where division is made according to each corresponding function to obtain each functional module.

Although this application may describe many specific details, these should not be interpreted as limiting the scope of the invention but rather as descriptions of particular characteristics of certain implementations. Certain features described in the context of a single embodiment can also be implemented in combination within a single embodiment. Conversely, various features described within the context of a single embodiment can also be implemented individually or in any suitable sub-combination across multiple embodiments. Additionally, although certain features may initially be described as functioning together in specific combinations, in some cases, one or more features can be removed from the combination, and the described combination may still function effectively with a subset or variation of that subset. Similarly, while operations may be depicted in a particular sequence in the illustrations, this should not be understood as requiring that the operations must be executed in the specific order shown or that all the depicted operations must be performed to achieve the desired result.

Although the embodiments described above reveal only a few examples and implementations, modifications, alterations, and enhancements can be made to the disclosed examples and implementations without departing from the disclosed content.

In conclusion, while the present invention has been disclosed through the embodiments described above, these are not intended to limit the scope of the invention. Those skilled in the relevant technical field, without departing from the spirit and scope of the invention, may make various changes and refinements. Therefore, the protection scope of this invention should be defined by the appended claims.

What is claimed is:

1. An image feature matching localization method, comprising:
performing feature analysis on a local image and a plurality of global images to obtain respective feature points and respective feature descriptor of the local image and the global images;
partitioning the local image into a plurality grid blocks;
performing feature matching between the feature points of a first grid block of the local image and the feature points of the global images to obtain a plurality of feature point matching results;
performing clustering analysis on the feature point matching results to calculate a target region of one of the global images corresponding to the first grid block, wherein the target region satisfies a first condition indicating that a first feature point average neighboring distance of the target region is less than or equal to a second feature point average neighboring distance of the first grid block of the local image;
determining whether to retain or discard the feature points within the first grid block based on a feature point matching relationship and whether corresponding to the target region in the global image;
analyzing a first pipeline direction of the first grid block in the local image and a second pipeline direction of the target region in the global image, calculating a first angle between the first pipeline direction and a first feature point regression line in the local image, and calculating a second angle between the second pipeline direction and a second feature point regression line in the global image;
adjusting the selection of feature points by calculating a feature point set such that an angular difference between the first angle and the second angle is less than a threshold value;
performing outer contour region analysis based on a feature point distribution from a regression analysis result of the global image to obtain a grid block localization result; and
performing spatial union processing based on a set of localization results of the grid blocks corresponding to the global images, and calculating an outer contour spatial region as a localization result of the local image on the global images.

2. The image feature matching localization method of claim 1, wherein:
the first feature point average neighboring distance x and the second feature point average neighboring distance y are defined as:
$$x or y = \frac{\sum pixel distance between one feature point and a closet feature point}{total numbe of feature points} ;$$
when performing clustering analysis of the feature point matching results, in response to the first condition not being satisfied, selecting a feature point from the global image and discarding the selected feature point until the first condition is satisfied; and
if the first condition remains unsatisfied after all the feature points of the global image have been discarded, determining that no overlapping region exists between the first grid block and the global image.

3. The image feature matching localization method of claim 1, wherein:
calculating the optimal feature point set such that the angular difference between the first angle and the second angle is less than the threshold value; and
if no optimal solution is found, determining that the first grid block is to be disregarded, wherein the feature point set corresponds to detailed feature point analysis results in an overlapping region from different viewpoints.

4. The image feature matching localization method of claim 1, wherein:
individually processing the grid blocks of the local image to obtain the set of localization results of the grid blocks corresponding to the global images.

5. The image feature matching localization method of claim 1, wherein:
performing a local image feature block partitioning step to obtain the plurality of grid blocks of the local image;
the local image feature block partitioning step determines a grid size;
the local image feature block partitioning step sets a maximum number of feature points within each of the grid blocks; and
calculating the number of rows and columns of the first grid block.

6. The image feature matching localization method of claim 1, wherein:
in a block-to-global image matching step, performing feature matching between each grid block of the local image and the global images using a feature matching similarity algorithm to obtain an individual coarse localization region of each grid block of the local image within the global images.

7. The image feature matching localization method of claim 1, wherein:
the first angle is denoted as ∠α and the second angle as ∠β, satisfying ∠α=∠β±∠γ;
if ∠α and ∠β do not satisfy ∠α=∠β±∠γ, selecting a feature point with a matching relationship in the local image and the global images and discarding the selected feature point, followed by recalculating ∠α and ∠β to determine whether ∠α=∠β±∠γ is satisfied; and
responding to the condition ∠α=∠β±∠γ remaining unsatisfied after all the feature points of the global image have been, determining that the first grid block is to be disregarded.

8. The image feature matching localization method of claim 1, wherein:
based on the feature point distribution from the regression analysis result of the global image, performing outer contour region calculation on a feature point coordinate information of the global image to obtain the localization result of the grid block; and
sequentially processing all grid blocks of the local image to obtain a set of localization results of the grid blocks corresponding to the global image.

9. The image feature matching localization method of claim 1, wherein:
the localization result indicates a partial contour region of the local image and a corresponding matching partial contour region of the global image.

10. An image feature matching localization system, comprising:
a storage unit;
a display unit; and
a processor, coupled to and control the storage unit and the display unit,
wherein the processor is configured for:
performing feature analysis on a local image and a plurality of global images to obtain respective feature points and respective feature descriptor of the local image and the global images;
partitioning the local image into a plurality grid blocks;
performing feature matching between the feature points of a first grid block of the local image and the feature points of the global images to obtain a plurality of feature point matching results;
performing clustering analysis on the feature point matching results to calculate a target region of one of the global images corresponding to the first grid block, wherein the target region satisfies a first condition indicating that a first feature point average neighboring distance of the target region is less than or equal to a second feature point average neighboring distance of the first grid block of the local image;
determining whether to retain or discard the feature points within the first grid block based on a feature point matching relationship and whether corresponding to the target region in the global image;
analyzing a first pipeline direction of the first grid block in the local image and a second pipeline direction of the target region in the global image, calculating a first angle between the first pipeline direction and a first feature point regression line in the local image, and calculating a second angle between the second pipeline direction and a second feature point regression line in the global image;
adjusting the selection of feature points by calculating a feature point set such that an angular difference between the first angle and the second angle is less than a threshold value;
performing outer contour region analysis based on a feature point distribution from a regression analysis result of the global image to obtain a grid block localization result; and
performing spatial union processing based on a set of localization results of the grid blocks corresponding to the global images, and calculating an outer contour spatial region as a localization result of the local image on the global images.

11. The image feature matching localization system of claim 10, wherein the processor is configured for:
defining a first feature point average neighboring distance x and a second feature point average neighboring distance y as:
$$x or y = \frac{\sum pixel distance between one feature point and a closet feature point}{total numbe of feature points} ;$$
when performing clustering analysis of the feature point matching results, in response to the first condition not being satisfied, selecting a feature point from the global image and discarding the selected feature point until the first condition is satisfied; and
if the first condition remains unsatisfied after all the feature points of the global image have been discarded, determining that no overlapping region exists between the first grid block and the global image.

12. The image feature matching localization system of claim 10, wherein the processor is configured for:
calculating the optimal feature point set such that the angular difference between the first angle and the second angle is less than the threshold value; and
if no optimal solution is found, determining that the first grid block is to be disregarded, wherein the feature point set corresponds to detailed feature point analysis results in an overlapping region from different viewpoints.

13. The image feature matching localization system of claim 10, wherein the processor is configured for:
individually processing the grid blocks of the local image to obtain the set of localization results of the grid blocks corresponding to the global images.

14. The image feature matching localization system of claim 10, wherein the processor is configured for:
performing a local image feature block partitioning to obtain the plurality of grid blocks of the local image;
performing the local image feature block partitioning to determine a grid size;
performing the local image feature block partitioning to set a maximum number of feature points within each of the grid blocks; and
calculating the number of rows and columns of the first grid block.

15. The image feature matching localization system of claim 10, wherein the processor is configured for:
in block-to-global image matching, performing feature matching between each grid block of the local image and the global images using a feature matching similarity algorithm to obtain an individual coarse localization region of each grid block of the local image within the global images.

16. The image feature matching localization system of claim 10, wherein the processor is configured for:
denoting the first angle as ∠α and the second angle as ∠β, satisfying ∠α=∠β±∠γ;
if ∠α and ∠β do not satisfy ∠α=∠β±∠γ, selecting a feature point with a matching relationship in the local image and the global images, and discarding the selected feature point, and recalculating ∠α and ∠β to determine whether ∠α=∠β±∠γ is satisfied; and
responding to the condition ∠α=∠β±∠γ remaining unsatisfied after all the feature points of the global image have been, determining that the first grid block is to be disregard.

17. The image feature matching localization system of claim 10, wherein the processor is configured for:
based on the feature point distribution from the regression analysis result of the global image, performing outer contour region calculation on a feature point coordinate information of the global image to obtain the localization result of the grid block; and
sequentially processing all grid blocks of the local image to obtain a set of localization results of the grid blocks corresponding to the global image.

18. The image feature matching localization system of claim 10, wherein the processor is configured for:
generating the localization result indicates a partial contour region of the local image and a corresponding matching partial contour region of the global image.
